(19) United States
(12) Patent Application Publication
(10) Pub. No.: US 2014/0141188 A1
(43) Pub. Date: May 22, 2014

(54) HALOGEN-FREE RETARDANT ACRYLIC RESIN AND MOLDED ARTICLE

(71) Applicant: INDUSTRIAL TECHNOLOGY RESEARCH INSTITUTE, Hsinchu (TW)

(72) Inventors: Feng-Ming HSIEH, Tainan City (TW); Chun-Yen CHEN, Tainan City (TW); Yi-Lun HSU, Tainan City (TW); Kuo-Chen SHIH, Kaohsiung City (TW)

(73) Assignee: INDUSTRIAL TECHNOLOGY RESEARCH INSTITUTE, Hsinchu (TW)

(21) Appl. No.: 13/728,556

(22) Filed: Dec. 27, 2012

(30) Foreign Application Priority Data
Nov. 20, 2012 (TW) 101143194

(51) Int. Cl. C08F 230/02

(52) U.S. Cl. CPC C08F 230/02
USPC 428/36.92; 526/277; 521/149; 442/327

(57) ABSTRACT

Disclosed is a halogen-free retardant acrylic resin, including a copolymer of an acrylate monomer (I) and a phosphorus-containing monomer (II), wherein R1 is H or methyl; R2 is H, alkyl, ester, alkyl ester, aryl, or heteroaryl, and R3 is H or methyl, and X is (CH₂)ₓ, x being an integer of 1-11, (CH₂CH₂O)_{y}, y being an integer of 1-5, or (CH₂)_{z}O, z being an integer of 2-10, and n is an integer or a non-integer of 1-2. A molded article of the halogen-free retardant acrylic resin is also provided.

### CROSS REFERENCE TO RELATED APPLICATIONS

This application claims priority of Taiwan Patent Application No. 101143194, filed on 20, Nov., 2012, the entirety of which is incorporated by reference herein.

### BACKGROUND

1. Technical Field

The technical field relates to an acrylic resin, and in particular, relates to a phosphorus-containing halogen-free retardant acrylic resin copolymer.

2. Description of the Related Art

Generally, acrylic resin is superior to many other kinds of resin in transmittance, weatherability, and hardness, and can also be easily molded. Thus, it is widely used in various fields, including the building material, electronics, furniture, vehicle, decoration, and the like. However, acrylic resin is highly flammable, which can be easily ignited and burst into flames, wherein if so, a fire would spread rapidly, causing severe damage. Moreover, burning of acrylic resin discharges toxic monomers. The above deficiencies have limited the development of acrylic resin in the fields with fire safety concerns.

Considering the aforementioned problems, retardant acrylic resins are generally added to fire retardants or copolymerized with retardant monomers. Flame retardants can be divided into two categories: organic and inorganic, wherein a large quantity of the inorganic type needs to be used to achieve retardancy. However, an excess quantity causes deterioration of physical properties. The organic type mainly includes halogen-based and phosphorus-based compounds, wherein halogen-based compounds are not environmentally safe and may also harm humans when in contact, due to the resulting product after the burning of dioxins, and halogen hydride, and a the production of a lot of smoke. The use of halogen-containing fire retardants has become illegal in most countries. Thus, development of the organic type of flame retardants is currently focused on phosphorus-based compounds. However, due to heterogeneity and soft, long carbon chains of phosphorus-based fire retardants, the incorporation or the copolymerization of the phosphorus-based fire retardants often reduce the mechanical strength, transmittance, and thermal resistance of acrylic resins.

Accordingly, it is desirable to have an acrylic resin having improved fire retardancy without compromising mechanical strength, transmittance, and thermal resistance, available.

### BRIEF SUMMARY

The disclosure provides a halogen-free retardant acrylic resin, including a copolymer of an acrylate monomer (I) and a phosphorus-containing monomer (II):

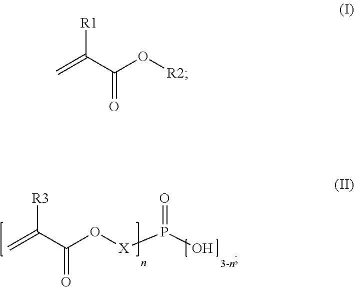

wherein R1 is H or methyl; R2 is H, alkyl, ester, alkyl ester, aryl, or heteroaryl, and R3 is H or methyl, and X is (CH₂)ₓ, x being an integer of 1-11, (CH₂CH₂O)_{y}, y being an integer of 1-5, or (CH₂)_{z}O, z being an integer of 2-10, and n is an integer or a non-integer of 1-2.

The disclosure also provides an article molded from the halogen-free retardant acrylic resin.

### DETAILED DESCRIPTION OF DISCLOSED EMBODIMENTS

The following description is of the best-contemplated mode of carrying out disclosed embodiments. This description is made for the purpose of illustrating the general principles of the embodiments and should not be taken in a limiting sense. The scope of disclosed embodiments is best determined by reference to the appended claims.

Reference throughout the specification to “one embodiment” or “an embodiment” means that a particular feature, structures, or characteristic described in connection with the embodiment is included in at least on embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Common acrylic resins tend to generate various free radicals (e.g. H. or OH.) when burnt or heated with a temperature close to thermal pyrolysis. These free radicals will attack the acrylic resin to induce a chain reaction of pyrolysis, resulting in a continuous burning that destroys the structural integrity of the acrylic resin. Thus, one characteristic of acrylic resins is low fire retardancy. Even if acrylic resins or their composites are modified to improve fire retardancy, their structures would tend to soften when heated, thus, hindering superior thermal resistance and transmittance. To solve the above problems, the phosphorus-containing acrylic resin of the disclosure is formed by copolymerizing the acrylic resin with a phosphorus-containing monomer, to improve fire retardancy and thermal resistance while maintaining high transmittance.

The acrylic resin of the disclosure is formed by copolymerization of an acrylate monomer of Formula (I) and a phosphorus-containing monomer of Formula (II).

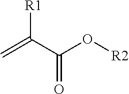

The functional group R1 in Formula (I) may include hydrogen or methyl, and the functional group R2 may include hydrogen, alkyl, ester, alkyl ester, aryl, or heteroaryl. The above alkyl group may include straight or branched chain alkyl groups having 1 to 6 carbon atoms, and cyclic alkyl groups having 3 to 8 carbon atoms, for example, methyl, ethyl, n-propyl, isopropyl, n-butyl, sec-butyl, tert-butyl, n-pentyl, n-hexyl, cyclopropyl, cyclopentyl, cyclobutyl, cyclohexyl, cycloheptyl, cyclooctyl, or other suitable alkyl groups. The above ester group may include the ester groups having 1-6 carbon atoms, for example, sulfuric acid ester, thiol ester, phosphate, carbonate ester, hydroxy ester, carboxylate ester, polyurethane group, vinyl ester, carbamate, or other suitable ester groups. The above alkyl ester group may include the alkyl ester groups having 1-6 carbon atoms, for example, methyl ester, ethyl ester, n-propyl ester, isopropyl ester, tert-butyl ester, or other suitable alkyl ester groups. The above aryl group may include aryl groups having 6-14 carbon atoms, for example, phenyl, benzyl, naphthyl, or other suitable aryl groups. The above heteroaryl group may include heteroaryl group having 4-15 heteroatoms such as C, N, O, or S, for example, pyridyl, pyrazinyl, pyrimidinyl, pyridazinyl, pyrazolyl, indolyl, quinolinyl, isoquinolinyl, furanyl, oxazolyl, thiazolyl, thienyl, or other suitable heteroaryl groups. Illustrative examples of the acrylate monomer may include methacrylate, ethyl acrylate, butyl acrylate, octyl acrylate, methyl methacrylate, ethyl methacrylate, cycloalkyl methacrylate, hydroxyethyl methacrylate, glycidyl methacrylate, aryl methacrylate, benzyl methacrylate, 2-ethylhexyl acrylate, 2-ethoxyethyl methacrylate, ethyl 2-cyanopropenoate, or other suitable acrylate monomers.

The phosphorus-containing monomers suitable for use herein has an ethylenically double bond and a phosphate group capable of forming hydrogen bonding in its molecule, as shown in Formula (II) below. In an embodiment, n is an integer or non-integers in a range of 1-2, wherein

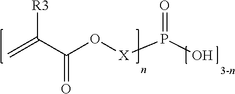

and the non-integer represents a mixture of at least two kinds of a phosphorus-containing monomers. Table (1) enumerates some examples of a phosphorus-containing monomers, wherein R3 group may be hydrogen or methyl, wherein the X group may include (CH₂)ₓ with x between 1-11, such as 1-3, (CH₂CH₂O)_{y} with y between 1-5, such as 1-2, and (CH₂)_{z}O with z between 2-11, such as 2-5, or the like. In some embodiments, X is (CH₂)_{z}O, and z is an integer between 2-5, as shown in Formula (III) below

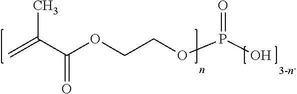

TABLE 1

| NO | R1 | X | n |
|---|---|---|---|
| 1 | H | CH₂ | 1 |
| 2 | H | (CH₂)₂ | 2 |
| 3 | H | (CH₂)₃ | 1.5 |
| 4 | H | (CH₂)₄ | 1.25 |
| 5 | H | (CH₂)₅ | 1.75 |
| 6 | H | CH₂CH₂O | 1 |
| 7 | H | (CH₂CH₂O)₂ | 2 |
| 8 | H | (CH₂CH₂O)₃ | 1.5 |
| 9 | H | (CH₂CH₂O)₄ | 1.25 |
| 10 | H | (CH₂CH₂O)₅ | 1.75 |
| 11 | H | (CH₂)₂O | 1 |
| 12 | H | (CH₂)₃O | 2 |
| 13 | H | (CH₂)₄O | 1.5 |
| 14 | H | (CH₂)₅O | 1.25 |
| 15 | CH₃ | CH₂ | 1.75 |
| 16 | CH₃ | (CH₂)₂ | 1 |
| 17 | CH₃ | (CH₂)₃ | 2 |
| 18 | CH₃ | (CH₂)₄ | 1.5 |
| 19 | CH₃ | (CH₂)₅ | 1.25 |
| 20 | CH₃ | (CH₂)₆ | 1.75 |
| 21 | CH₃ | CH₂CH₂O | 1 |
| 22 | CH₃ | (CH₂CH₂O)₂ | 2 |
| 23 | CH₃ | (CH₂CH₂O)₃ | 1.5 |
| 24 | CH₃ | (CH₂CH₂O)₄ | 1.25 |
| 25 | CH₃ | (CH₂CH₂O)₅ | 1.75 |
| 26 | CH₃ | (CH₂)₂O | 1 |
| 27 | CH₃ | (CH₂)₃O | 2 |
| 28 | CH₃ | (CH₂)₄O | 1.5 |
| 29 | CH₃ | (CH₂)₅O | 1.25 |
| 30 | CH₃ | (CH₂)₆O | 1.75 |

The double bonds of the phosphorus-containing monomers can copolymerize with the double bonds of the acrylic monomers by free radical reaction to form phosphorus-containing acrylic resin. The phosphate structure will condense and dehydrate when burned and will in turn facilitate the dehydration of the carboxylic group of acrylic resin to reduce the burning temperature, and further, carbonizes the acrylic resin to form an incombustible char layer, hindering the transfer of combustible gas and heat. On the other hand, the phosphorus-containing compound generates HPO. or H₂PO., which captures free radicals to inhibit chain reactions, thus, improving the fire retardancy. Furthermore, the hydrogen bonding of the phosphorus-containing monomers can form physical crosslinking bi-functionality (e.g. when n>1), and can form chemical crosslinking, both of which may stabilize the structure. As such, the fire retardancy and the thermal resistance can be improved.

In some embodiments, the transmittance of the phosphorus-containing acrylic copolymer resin is between about 70% to about 99%, preferably about 90% to about 99%. The glass transition temperature of the phosphorus-containing acrylic copolymer resin is between 95° C.-125° C., preferably above 110° C. The result of UL-94 testing shows the acrylic resin of the embodiments reaching at least the V2 class, or even the V1 and V0 class.

In an embodiment, the composition ratio of the halogen-free retardant acrylic copolymer resin includes about 40 wt %-95 wt % of acrylate monomers, such as 50 wt %-85 wt %, and about 5 wt %-60 wt % of a phosphorus-containing monomers, such as 15 wt %-50 wt %. In addition, it may also include about 0.1 wt %-5 wt % of free radical initiators, such as 0.1 wt %-2wt %. The acrylate monomers and the phosphorus-containing monomers in the composition ratio of the above may be copolymerized through methods known in the prior art, which include: solution polymerization, precipitation polymerization, suspension polymerization, bulk polymerization, emulsion polymerization, or the like. It is preferred to use the solution polymerization method using free radical initiators, wherein the free radical initiators may include, but are not limited to acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfonium compounds, for example, azo compounds, peroxides, and acetophenones, wherein azodiisobutyronitrile (AIBN) is particularly preferred. The solvent used in the solution polymerization may be ethyl acetate, butyl acetate, acetone, methyl ethyl ketone, methyl isobutyl ketone, cyclohexanone, tetrahydrofuran, dioxane, n,n-dimethyl formamide, n,n-dimethyl toxidromes, benzene, toluene, acetylation toluene, dichloromethane, chloroform, dichloroethane, methanol, ethanol, 1-propanol, 2-propanol, 1-butanol, or combinations thereof.

In some embodiments, the halogen-free retardant acrylic copolymer resin may be processed to be formed into various required articles as desired, such as films, sheets, an injection-molded body, a thermal-forming body, foam, fiber, a monofilament, a non-woven fabric, yarn, a laminate, a container, and/or other suitable article shapes through processing steps known in the art, for example, pouring molding, injection molding, extrusion molding, or the like. In some embodiments, the halogen-free retardant acrylic copolymer resin may be applied to building materials, furniture, electronics, traffic tools, precision machines, electronic communication devices, fabrics, provision packing, agriculture, forestry, fisheries, medical supplies, or the like. Advantageous properties such as high transmittance, weatherability, superior hardiness, better processability, and the improved retardancy and thermostablity over the conventional acrylic resins may be provided.

The phosphorus-containing monomer of the embodiments is well compatible and highly reactive with acrylic monomer and can maintain a high transmittance of above 90% after copolymerization. The hydrogen bonding and ethylentically double bonds may improve the thermal resistance of the acrylic resin, due to the good compatibility between monomers. In some embodiments, a high transmittance can be maintained even during processes having a high phosphorus content such as 40 wt %, so as to increase its thermal resistance and improve the retardancy to at least the V2 class of UL-94 testing.

### EXAMPLE 1

30 g of a phosphorus-containing monomer mixture (Formula (III), n=1.5; i.e. equimolar mixture of compound CAS No. 24599-21-1 and compound CAS No. 32435-46-4.) was added into 120 g of methyl acrylate (MMA) prepolymer, such that the MMA took up 80 wt % and the phosphorus-containing monomer took up the other 20 wt %, and also 0.45 g of azodiisobutyronitrile (AIBN) was added as a free radical initiator. After thoroughly mixing, the mixture was poured into a glass casting mold and sealed. The casting mold was immersed into a water bath at a constant temperature of 60° C. for 4 hours, and then the casting mold was baked in an oven at 110° C. for 2 hours. An acrylic plate was obtained after cooling, and then the transmittance was measured according to the ASTM D1003-00, the glass transition temperature was measured by the ASTM D7426-08, and retardancy was tested by UL-94 vertical flame testing. The properties of the obtained acrylic plate were as shown in Table (2).

### EXAMPLE 2

The same procedure as in Example 1 was repeated, except that 105 g (70 wt %) of MMA, and 45 g (30wt %) of the phosphorus-containing monomer (Formula (III), n=1.5; i.e. equimolar mixture of compound CAS No. 24599-21-1 and compound CAS No. 32435-46-4.) were used. The properties of the obtained acrylic plate were as shown in Table (2).

### EXAMPLE 3

The same procedure as in Example 1 was repeated, except that 90 g (60 wt %) of MMA, and 60 g (40 wt %) of the phosphorus-containing monomer (Formula (III), n=1.5; i.e. equimolar mixture of compound CAS No. 24599-21-1 and compound CAS No. 32435-46-4.) were used. The properties of the obtained acrylic plate were as shown in Table (2).

### EXAMPLE 4

The same procedure as in Example 1 was repeated, except that 112 g (75 wt %) of MMA, and 37.5 g (25 wt %) of the phosphorus-containing monomer (Formula (III), n=1; compound CAS No. 24599-21-1.) were used. The properties of the obtained acrylic plate were as shown in Table (2).

### EXAMPLE 5

The same procedure as in Example 1 was repeated, except that 97.5 g (65 wt %) of MMA, and 52.5 g (35 wt %) of the phosphorus-containing monomer (Formula (III), n=1; compound CAS No. 24599-21-1.) were used. The properties of the obtained acrylic plate were as shown in Table (2).

### EXAMPLE 6

The same procedure as in Example 1 was repeated, except that 112.5 g (75 wt %) of MMA, and 37.5 g (25 wt %) of the phosphorus-containing monomer (Formula (II), R3=CH₃, X=CH₂, and n=1.) were used. The properties of the obtained acrylic plate were as shown in Table (2).

### Comparative Example 1

The same procedure as in Example 1 was repeated, except that 150 g (100 wt %) of MMA was used. The properties of the obtained acrylic plate were as shown in Table (2).

### Comparative Example 2

The same procedure as in Example 1 was repeated, except that 135 g (90 wt %) of MMA, and 15 g (10 wt %) of the phosphorus-containing monomer (Formula (III), n=1.5; i.e. equimolar mixture of compound CAS No. 24599-21-1 and compound CAS No. 32435-46-4.) were used. The properties of the obtained acrylic plate were as shown in Table (2).

### Comparative Example 3

The same procedure as in Example 1 was repeated, except that 40 g (80 wt %) of MMA, and 10 g (30 wt %) of the phosphorus-containing monomer (Formula (IV)) were used, and only 0.15 g of AIBN was added. The properties of the obtained acrylic plate were as shown in Table (2).

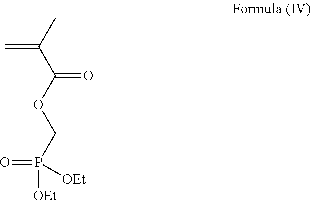

### Comparative Example 4

The same procedure as in Example 1 was repeated, except that 32.5 g (65 wt %) of MMA, and 17.5 g (35 wt %) of the phosphorus-containing monomer (Formula (V), compound CAS No. 682-30-4) were used, and only 0.15 g of AIBN was added. The properties of the obtained acrylic plate were as shown in Table (2).

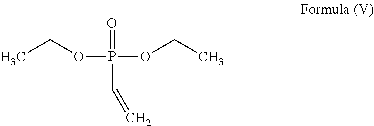

TABLE 2

| | Example 1 | Example 2 | Example 3 | Example 4 | Example 5 | Example 6 |
|---|---|---|---|---|---|---|
| Transmittance (%) | 92.1 | 92.3 | 90.6 | 92.5 | 91.2 | 92.9 |
| ΔTg (° C.)* | 5.5 | 9.1 | 11.9 | 10.3 | 13 | 12.5 |
| UL94-V | V2 | V0 | V0 | V0 | V1 | V0 |
| | Comparative | Comparative | Comparative | Comparative | | |
| | Example 1 | Example 2 | Example 3 | Example 4 | - | - |
| Transmittance (%) | 93.1 | 92.5 | 91.9 | 90.4 | | |
| ΔTg (° C.)* | 0 | 3.3 | −12.4 | −26.7 | | |
| UL94-V | Fail | Fail | V2 | V2 | | |

*ΔTG = Tg (example) − Tg (PMMA)
*Tg of PMMA = 106.2° C.

The results of Table (2) shows that the Examples of the disclosure maintained a general level of the transmittance of the acrylic resin, and exhibited improved thermal resistance over the PMMA without phosphorus-containing monomer (Comparative Example 1) or PMMA with only 10 wt % of the phosphorus-containing monomer (Comparative Example 2). The copolymer of the Examples had a glass transition temperature of at least 5.5° C. higher than general PMMA. It can be seen from the Comparative Example 3 and 4 that due to the absence of the crosslinking of hydrogen bonding and bi-functionality of the phosphorus-containing monomers, the copolymerization reactivity was lower than that of the embodiments, resulting in a considerable amount of residual monomers in the polymer, which led to poor thermal resistance and susceptibility to heat deformation. The Examples reached at least the V2 class of UL-94 vertical flame testing, whilst the Comparative Example 1 and 2 failed the UL-94 vertical flame testing.

While disclosed embodiments have been described by way of example and in terms of the preferred embodiments, it is to be understood that the embodiments are not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A halogen-free retardant acrylic resin, comprising a copolymer of an acrylate monomer (I) and a phosphorus-containing monomer (II): 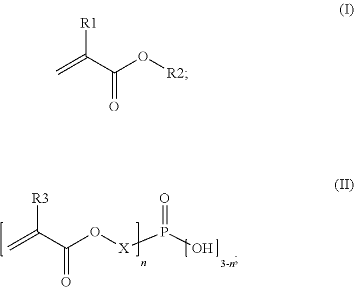
wherein R1 is H or methyl;
R2 is H, alkyl, ester, alkyl ester, aryl, or heteroaryl; and
R3 is H or methyl, and
X is (CH₂)ₓ, x being an integer of 1-11, (CH₂CH₂O)_{y}, y being an integer of 1-5, or (CH₂)_{z}O, z being an integer of 2-10, and
n is an integer or a non-integer of 1-2.

2. The halogen-free retardant acrylic resin as claimed in claim 1, wherein the acrylate monomer comprises: methacrylate, ethyl acrylate, butyl acrylate, octyl acrylate, methyl methacrylate, ethyl methacrylate, cycloalkyl methacrylate, hydroxyethyl methacrylate, glycidyl methacrylate, aryl methacrylate, benzyl methacrylate, 2-ethylhexyl acrylate, 2-ethoxyethyl methacrylate, or ethyl 2-cyanopropenoate.

3. The halogen-free retardant acrylic resin as claimed in claim 1, wherein X is (CH₂)_{z}O, and z is an integer of 2-5.

4. The halogen-free retardant acrylic resin as claimed in claim 1, wherein the phosphorus-containing monomer is the monomer of Formula (III), and n is an integer or a non-integer of 1-2:

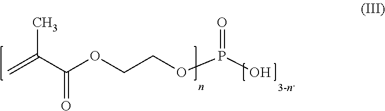

5. The halogen-free retardant acrylic resin as claimed in claim 1, comprising about 50 wt %-85 wt % of the acrylate monomer, and about 15 wt %-50 wt % of the phosphorus-containing monomer.

6. The halogen-free retardant acrylic resin as claimed in claim 5, further comprising 0.1 wt %-2 wt % of a free-radical initiator, based on the total amount of monomers.

7. The halogen-free retardant acrylic resin as claimed in claim 6, wherein the free-radical initiator comprises azo compounds, peroxides, acetophenones, or combinations thereof.

8. The halogen-free retardant acrylic resin as claimed in claim 1, having a transmittance of about 70%-99%.

9. The halogen-free retardant acrylic resin as claimed in claim 1, wherein a glass transition temperature of the copolymer is in a range of about 95° C.-125° C.

10. The halogen-free retardant acrylic resin as claimed in claim 1, wherein the copolymer has a sufficient flame retardancy to pass the UL-94 vertical flame test.

11. An article molded from the halogen-free retardant acrylic resin according to claim 1.

12. The article as claimed in claim 11, comprising films, sheets, injection-molded bodies, thermal-forming bodies, foams, fibers, monofilaments, non-woven fabrics, yarns, laminates, or containers.
